(19) United States
(12) Patent Application Publication
(10) Pub. No.: US 2004/0132002 A1
(43) Pub. Date: Jul. 8, 2004

(54) Methods for preserving blood

(76) Inventor: Jackson Streeter, Reno, NV (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/666,519

(22) Filed: Sep. 17, 2003

Related U.S. Application Data
(63) Continuation-in-part of application No. 10/287,432, filed on Nov. 1, 2002.
(63) Continuation-in-part of application No. 10/338,949, filed on Jan. 8, 2003.
(60) Provisional application No. 60/411,468, filed on Sep. 17, 2002.
(60) Provisional application No. 60/502,147, filed on Sep. 11, 2003.

(51) Int. Cl. A01N 1/02

(52) U.S. Cl. 435/2

(57) ABSTRACT

Methods for preserving donated blood and blood products are described, including embodiments which involve the application of a preservation effective amount of electromagnetic energy from a laser or other electromagnetic energy source, the energy having a wavelength in the visible to near-infrared wavelength range and delivering the effective amount of energy includes selecting a predetermined power density (mW/cm²) of energy to deliver to the blood. The methods can be used in combination with other blood preservation techniques including hypothermic storage and the use of preservative compositions.

### Related Application Data

This application claims priority under 35 U.S.C. § 119(e) to U.S. Provisional Application Serial No. 60/411,468, filed Sep. 17, 2002, and ______, entitled APPARATUS AND METHOD FOR PROVIDING PHOTOTHERAPY TO THE BRAIN, filed Sep. 11, 2003, and is a continuation-in-part of U.S. patent application Ser. Nos. 10/287,432, filed Nov. 1, 2002, and Ser. No. 10/338,949, filed Jan. 8, 2003, the disclosures of which are hereby incorporated by reference in their entirety.

### BACKGROUND OF THE INVENTION

1. Field of the Invention

This invention relates to a method for extending the shelf life of blood products, including platelets and whole blood, preferably of humans, and more particularly to a method that inhibits the cellular components of blood from degenerating during storage and/or transport.

2. Description of the Related Art

During both elective and emergency surgery, transfusion of previously donated, stored blood is often a vital necessity. However, once donated blood is removed from the physiological environment of the donor's body, the multiple cellular components of blood tissue, which include erythrocytes, leukocytes, and platelets suspended in plasma, are subject to metabolic rundown, depletion of high-energy phosphates, and ultimately cell compromise and death. Thus the time over which blood can be stored and still be safely transfused is limited. Even using blood products that have been collected and stored according to standards of the blood banking industry, the development of hepatic disorders is associated with blood transfusion and is presumably linked to compromise of blood during storage.

Hypothermic storage to preserve blood has long been known. Compositions for preserving blood are also known. In such compositions, one or more components are provided to help sustain cellular processes and avoid cell death and degradation. For example, are known that include added sugars to provide energy sources for sustaining cellular processes, inorganic salts for adjusting pH and osmotic pressure, and adenine to avert depletion of high-energy phosphate molecules adenosine triphosphate (ATP), adenosine diphosphate (ADP) and adenosine monophosphate (AMP). A composition using a phosphoric acid diester of ascorbic acid and tocopherol is known. However, hypothermic storage and the use of preservative compositions are relatively costly. Further, consumed additives such as adenosine eventually are depleted, thus limiting their effectiveness.

In the field of surgery, high-energy laser radiation is now well accepted as a surgical tool for cutting, cauterizing, and ablating biological tissue. High-energy lasers are now routinely used for vaporizing superficial skin lesions and, and to make deep cuts. For a laser to be suitable for use as a surgical laser, it must provide laser energy at a power sufficient to heat tissue to temperatures over 50 C. Power outputs for surgical lasers vary from 1-5 W for vaporizing superficial tissue, to about 100 W for deep cutting.

In contrast, low level laser therapy involves therapeutic administration of laser energy to a patient at vastly lower power outputs than those used in high energy laser applications, resulting in desirable biostimulatory effects while leaving tissue undamaged. For example, in rat models of myocardial infarction and ischemia-reperfusion injury, low energy laser irradiation reduces infarct size and left ventricular dilation, and enhances angiogenesis in the myocardium. (Yaakobi et al., J. Appl. Physiol. 90, 2411-19 (2001)). Low level laser therapy has been described for treating pain, including headache and muscle pain, and inflammation. The use of low level laser therapy to accelerate bone remodeling and healing of fractures has also been described. (See, e.g., J. Tuner and L. Hode, Low LEVEL LASER THERAPY, Stockholm:Prima Books, 113-16, 1999, which is herein incorporated by reference).

Against this background, a high level of interest remains in finding new and improved methods for preserving blood thus to extend the time period over which blood can be stored and still be used for transfusion.

### SUMMARY OF THE INVENTION

In one embodiment, a method for preserving donated blood includes delivering a preservation effective amount of electromagnetic energy to the donated blood, the electromagnetic energy having a wavelength in the visible to near-infrared wavelength range. Delivering the preservation effective amount of energy may include selecting a power density of energy to deliver to the blood.

In accordance with one embodiment, there is provided a method for treating extracorporeal blood, comprising delivering to at least a portion of cellular components of extracorporeal blood electromagnetic energy having a wavelength of about 670 nm to about 690 nm and/or about 810 nm to about 830 nm and a power density of at least about 0.01 mW/cm² wherein the electromagnetic energy is sufficient to increase the useable shelf life of treated blood as compared to untreated blood.

In accordance with one embodiment, there is provided a method for treating extracorporeal blood, comprising delivering to at least a portion of cellular components of extracorporeal blood electromagnetic energy in a quantity sufficient to prevent, reduce or retard damage to cellular components of the blood, said electromagnetic energy having a wavelength of about 630 nm to about 904 nm.

Preferred embodiments may also include one or more of the following: the energy is applied to donated blood placed in a transparent or translucent blood container such as a bottle or bag; the power density is selected to be at least about 0.01 mW/cm², including about 1 mW/cm²; and/or the energy has a wavelength of about 630 nm to about 904 mm, including about 680 nm, and about 820 nm.

### BRIEF DESCRIPTION OF THE DRAWINGS

FIG. 1 is a perspective view of one embodiment of an apparatus for transporting and/or treating blood or blood products.

### DETAILED DESCRIPTION OF THE PREFERRED EMBODIMENT

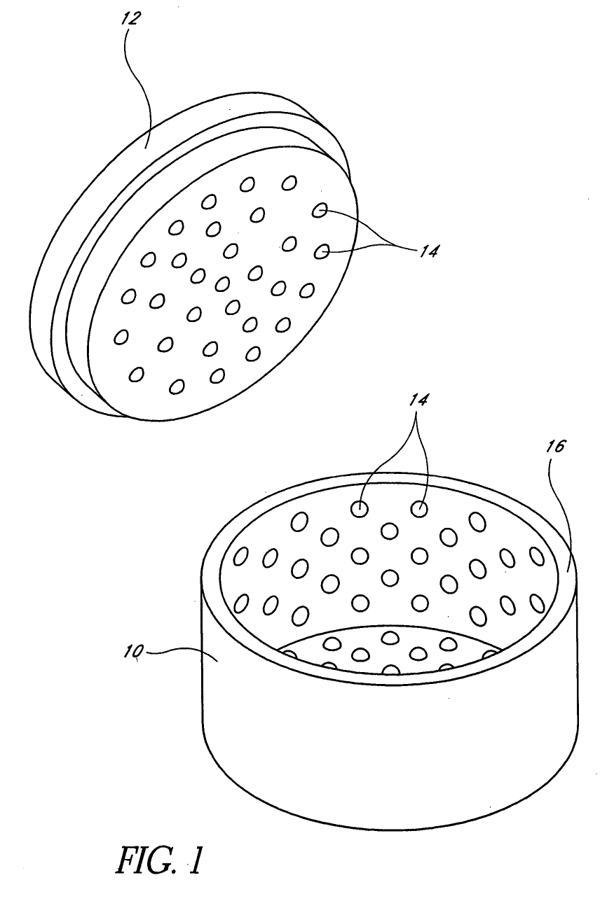

The methods to treat or preserve blood or blood products described herein may be practiced and described using, for example, a low level laser therapy apparatus such as that shown and described in U.S. Pat. No. 6,214,035, U.S. Pat. No. 6,267,780, U.S. Pat. No. 6,273,905 and U.S. Pat. No. 6,290,714, which are all herein incorporated by reference together with the references contained therein. In a preferred embodiment, they are practiced using an apparatus such as that shown in FIG. 1.

In accordance with one embodiment of method to treat or preserve blood or blood products is a low level laser apparatus including a handheld probe for delivering the electromagnetic energy to the blood. The probe includes a laser energy source emitting electromagnetic energy having a wavelength in the visible to near-infrared wavelength range, i.e., from about 630 nm to about 904 nm. The probe includes, for example, a single laser diode that provides about 100 mW to about 500 mW of total power output, or multiple laser diodes that together are capable of providing at least about 100 mW to about 500 mW of total power output. Other embodiments provide lower total power output, for example, about 1 mW or about 25 mW. The actual power output is preferably variable using a control unit electronically coupled to the probe, so that power of the light energy emitted can be adjusted in accordance with power density calculations as described below. The diodes used are, for example, continuously emitting GaAIAs laser diodes having a wavelength of about 830 nm. In one embodiment of apparatus for blood storage or transport as described infra, a plurality of such laser probes or light sources provide the light energy sources. Alternatively, the electromagnetic energy source is another type of source, for example a light-emitting diode (LED), or other light energy source, having a wavelength in the visible to near-infrared wavelength range. The level of coherence of a light energy source is not critical. A light energy source need not provide light having the same level of coherence as the light provided by a laser energy source.

In preferred methods, the electromagnetic energy has a wavelength in the visible to near-infrared wavelength range, and within a select range of power density (i.e., light intensity or power per unit area, in mW/cm²). The use of power densities within a particular range, as noted herein, appears to be a factor in producing beneficial effects for the cellular components of blood, thus enhancing preservation of the blood or blood products for transfusion or other clinical or scientific use. In a preferred embodiment, the electromagnetic energy delivered to the blood has a power density of about 0.01 mW/cm² to about 100 mW/cm², and, independent of the power of the electromagnetic energy source used and the dosage of the energy used, appears to improve the quality of the stored blood and enhance the preservation period of blood for transfusion. In an exemplary embodiment, the electromagnetic energy is applied to blood stored hypothermically, or at least at a temperature below the normal body temperature of the donor animal, preferably a human or other mammal. Alternatively, the electromagnetic energy is applied to blood stored under normothermic conditions, i.e., at near-normal physiologic temperature.

In preferred embodiments, the treatment parameters include one or more of the following and preferred storage and/or transport apparatuses have light sources capable of supplying energy having one or more of the following properties. Power densities of light at the level of the target cells of the blood are preferably between about 0.01 mW/cm² and about 100 mW/cm², including about 0.05, 0.1, 0.5, 1, 5, 10, 15, 20, 30, 40, 50, 60, 70, 80, and 90 mW/cm². In other embodiments, power densities include those above about 100 mW/cm², including about 250 mW/cm² and about 1000 mW/cm². In embodiments in which something surrounds the blood during treatment, such as a preservation medium or cooling material, or the bottle, bag or other container holding the blood, one should take into account any possible attenuation of the energy as it travels through such surrounding material. In most embodiments, however, the power density emitted by the source(s) will be substantially identical to the power density at the outside surface of the blood in the container. To achieve such power densities, preferred light energy sources, each alone or in combination, are capable of emitting light energy having a total power output of about 1 mW to about 500 mW, including about 5, 10, 15, 20, 30, 50, 75, 100, 150, 200, 250, 300, and 400 mW, but may also be as high as about 1000 mW or below 1 mW, such as about 0.01 mW. Preferably the light energy used for treatment has a wavelength in the visible to near-infrared wavelength range, i.e., from about 630 to about 904 nm, including about 780 nm to about 840 nm, including about 640, 660, 680, 700, 720, 740, 760, 780, 800 and 820 nm. Other suitable wavelengths include about 670 to about 690 nm, including about 675, 680, and 685 nm, and about 810 to about 830 nm, including about 815, 820, and 825 nm. The light may contain several wavelengths, or a broad band of wavelengths within this range, or it may be substantially monochromatic (i.e. one wavelength or a narrow band of wavelengths).

In one embodiment, the treatment proceeds continuously during substantially the entire period of time that the blood is being stored or transported, which may be anywhere from a several hours to several weeks. In other embodiments, the blood may be treated one or more times while it is being stored, with the treatment intervals being of a time, sequence, and duration as determined by a clinician or skilled technician. During the treatment, the light energy may be continuously provided, or it may be pulsed. In one embodiment, the light is pulsed, with the pulses being at least about 10 ns long, including about 100 ns, 1 ms, 10 ms, and 100 ms, and occurring at a frequency of up to about 1 kHz, including about 1 Hz, 10 Hz, 50 Hz, 100 Hz, 250 Hz, 500 Hz, and 750 Hz.

Without being bound by theory, it is believed that generally independently of the power and dosage of the electromagnetic energy used, electromagnetic energy delivered within a specified range of power densities provides a biostimulative effect on mitochondria of the cellular components of blood to avoid degradation of high-energy phosphate molecules that are known to contribute to tissue damage. The electromagnetic energy may also help to avoid other degradation mechanisms and/or enhance protective mechanisms or reactions in the blood and blood components. In any case, the observed biostimulative effect helps to maintain cellular integrity and prevents or retards cell damage during compromise of the blood's normal physiologic environment, i.e., during disruption of normal gas-exchange and flow such as may occur during storage of blood in containers before transfusion or other use.

The term “blood” as used herein is intended to encompass not only “whole” blood but also blood products including the cellular component, elements of “whole blood” including erythrocytes, leukocytes, and platelets.

The term “preservation effective” as used herein refers to a characteristic of an amount of electromagnetic energy wherein the amount of electromagnetic energy achieves the goal of preventing, avoiding, reducing or retarding cellular damage in blood, whether the cellular damage results directly or indirectly from mechanical trauma to the cells due to the use of equipment such as tubing, needles and valves, ischemia, degradation of high-energy phosphates, or any other tissue response to the disruption of function and the manipulation of blood that attends donation and storage. Blood which has been treated with a preservation effective amount of energy has an increased shelf life as compared to blood that has not been so treated.

Thus, in a broad aspect, methods directed toward preserving blood may include delivering to blood removed from a donor a preservation effective amount of electromagnetic energy, the electromagnetic energy having a wavelength in the visible to near-infrared wavelength range, wherein delivering the preservation effective amount of electromagnetic energy comprises selecting a predetermined power density of the energy to deliver to the blood. The predetermined power density is selected from power densities of at least about 1 mW/cm², and no greater than about 100 mW/cm². Especially suitable is a power density selected from the range of about 2 mW/cm² to about 20 mW/cm².

Generally, electromagnetic energy suitable for practicing the methods includes electromagnetic energy in the visible to near-infrared wavelength range, including wavelengths in the range of about 630 nm to about 904 nm. In an exemplary embodiment, the electromagnetic energy has a wavelength of about 830 nm, as delivered with a laser energy apparatus including GaAlAs diodes as the laser energy source.

Donated blood destined for storage is generally received in a transparent or translucent container such as a bag which is generally made from a polymeric material such as PVC or polyethylene. The material of the bag or container should allow the electromagnetic energy to pass through the container to reach the blood. The bag may or may not be treated with one or more blood preservation compositions. The blood is then exposed to the electromagnetic energy treatment by directing one or more energy sources toward one or more points on the surface of the container. The sources may be activated before or after the positioning step. In one embodiment, the one or more sources form part of a storage or transport apparatus. The energy source(s) may make contact directly with the surface of the blood container, or may be maintained a short distance away from the surface of the container, provided that the distance is not so large as to attenuate the power density of the energy actually reaching the surface of the container to a value that is below the desired treatment level.

In one embodiment, the electromagnetic energy is applied to blood stored hypothermically. Alternatively, the electromagnetic energy is applied to blood stored under normothermic conditions, i.e. at near-normal physiologic temperature. Under normothermic conditions the electromagnetic energy may be applied to blood for which a type of gas-exchange system is supplied, such as that described in U.S. Pat. No. 6,046,046.

Factors known to affect energy penetration which may be taken into account in the selection of the power density to be used include the type of blood being treated, the storage container, the distance between a source and the blood, and other materials which may be surrounding the blood. The extent to which the blood includes red cells and is therefore pigmented is usually a factor which affects the selection of power density within the stated range for treating the blood product. The higher the level of pigmentation, the higher the power density required to allow penetration of the energy into the volume of blood. Also, the packaging of the blood will affect the power density selected. The total volume and spatial configuration of the blood in its container will be considered in determining the power density to be used. A volume of blood having a relatively greater thickness or depth can be treated with a higher power density within the given range, as opposed to volume of blood packaged to as to have very little thickness or depth. To increase the exposure of a volume of blood to the energy, the blood may also be agitated by rotation or otherwise. Alternatively, the electromagnetic energy source or multiple sources can be mounted on apparatus that gradually or stepwise moves the energy source or sources over the surface of the blood containers.

The following describes one method of treating a unit of blood. Other methods are contemplated. In one embodiment, the energy is applied to at least one point on the blood container, the point having a diameter of about 1 cm. Thus, to most completely treat a unit of blood, which typically will have a surface area substantially larger than a spot having a diameter of about 1 cm, the energy is applied sequentially to a series of multiple spots over the surface of the blood container, the spots having centers that are separated by at least about 1 cm. The series of spots can be mapped out over the surface of the blood bag or container to aid in an orderly progression of energy applications that systematically cover the surface area of the blood bag or container as it is being treated from any one approach. Alternatively, some blood bags or containers may be susceptible of treatment from more than one approach, e.g. treatment from the frontal and rear aspects of the container, or from the frontal and side aspects. When multiple approaches are used, the power density supplied from any one source may be adjusted so that any one source contributes a fraction of the total predetermined power density selected to be delivered to the blood such that the multiple sources together deliver the total predetermined power density selected.

The precise power density selected for treating the blood is determined according to the judgment of a trained energy therapy technician and may be adjusted according to a number of factors, including the type of blood being treated as discussed above, the specific wavelength of energy selected, how long the blood has already been stored and under what conditions, the desired preservation time, whether the blood continues being preserved under hypothermic or normothermic conditions, whether a gas-exchange system is in use, and the like. In an embodiment, the power density is selected from the range described supra. It should be understood that the power density of the energy might be adjusted as preservation time elapses, or for use in combination with any other preservation agent or agents, especially preservation compositions added to the blood to achieve the desired effect of reducing tissue damage during preservation. For example, as preservation time elapses, the number (i.e. number of treatment points) and/or frequency of energy treatments may increase, and/or the selected power density may increase within the given range to achieve the desired effect of reducing blood tissue damage during preservation. Generally, as long as the blood remains viable, the energy therapy can be applied on a regular basis including, but not limited to, every quarter- or half-hour, hourly, 2-12 times daily, or daily:

In one embodiment, the blood may be stored, treated, and/or transported in apparatuses such as those described in applicant's copending U.S. patent application Ser. No. 10/338,949, filed Jan. 8, 2003, entitled METHOD FOR PRESERVING ORGANS FOR TRANSPLANT.

In one embodiment, the apparatus is a “light box,” including generally a media storage container for receiving the blood or other types of harvested tissue, and means for applying electromagnetic energy in accordance with the methods described above, i.e., at a selected power density, and wavelength, to the blood or other tissue therein contained. The basic configuration of one preferred type of “light box” is, for example, described in U.S. Pat. No. 4,951,482, which is herein incorporated by reference.

In one embodiment, the apparatus is a portable container suitable for hypothermic storage and/or transport of organs or tissue, such as blood, and includes a media storage container having a base and side walls extending from the base. The side walls have a plurality of openings therethrough, each opening configured to mate with an electromagnetic energy source, such as a laser probe as described supra, or LED or other light source, to form a fluid tight seal. The openings are configured, for example, with threads and an O-ring type gasket, the threads configured to mate with threads on an end of a laser probe serving as a laser energy source. The media storage container is configured to allow for suspension of the harvested tissue in a fluid preservation medium, and a primary cover mates with the media storage container to form a fluid-tight seal. In this exemplary embodiment, the apparatus further includes a secondary container having a base and side walls extending therefrom, and is configured to suspend the media storage container in a thermoregulatory fluid. A plurality of electromagnetic energy sources, for example laser energy sources, extend from the side walls of the secondary container. In one embodiment, each energy source mates with one of the plurality of openings on the media storage container side walls to form a fluid-tight seal against a thermoregulatory fluid contained in the secondary container. Similarly, the fluid-tight seal of the primary cover with the media storage container seals inside of the media storage container against the thermoregulatory fluid. In accordance with the methods described herein, the energy source(s) are preferably configured to emit light energy having one or more of the characteristics described supra. The energy sources and bag or other container holding blood or blood products are positioned relative to one another so that the energy sources direct the energy at the blood contained in the media storage container. In one embodiment, a secondary cover mates with the secondary container to contain a thermoregulatory fluid. The media storage container is sized appropriately to receive and secure a large solid organ up to about the size of an adult human liver or lung, or to hold one or several bags or other containers of blood or blood products. The secondary container is sized appropriately to receive the media storage container and a sufficient amount of thermoregulatory fluid to properly maintain the hypothermic condition, while yet remaining sufficiently compact that a single individual adult is able to carry or otherwise transport the apparatus. It will be appreciated that the apparatus and methods can be varied for application to maintaining a normothermic environment. For example, under normothermic conditions the light energy may be applied in connection with supplying a gas-exchange system, such as that described in U.S. Pat. No. 6,046,046, which is herein incorporated by reference.

One preferred embodiment of storage and/or transport apparatus for tissues, including blood, is illustrated in FIG. 1. The apparatus includes a container to receive and hold the blood which is preferably in a bag or other container. The container comprises a bottom portion 10 and a cover 12. The bottom portion 10 may be any suitable shape including, but not limited to, those having a base and at least one wall, such as the generally cylindrical shape illustrated in FIG. 1. The shape of the interior of the bottom portion may or may not correspond to its exterior shape. For example, the bottom portion of an embodiment may have a generally cubic exterior yet have a hemispherical shaped interior. In preferred embodiments, the exterior of the bottom portion 10 has at least one flat surface, preferably opposite the open end which mates with or engages the cover 12, so as to provide a stable resting surface for the apparatus. The cover 12 is shaped so as to mate with the bottom portion. In a preferred embodiment, the cover 12 and bottom portion 10 form a fluid-tight seal when placed together to aid in containment of any storage or preservation medium or bodily fluids that may be associated with the blood. The cover 12 and bottom portion 10 need not be two separate, removable pieces as illustrated; they may be single piece construction or attached together such as by a hinge or other such mechanism. The cover 12 and bottom portion 10 may further comprise a locking or latching mechanism, engaging threads or other suitable means for securing the two pieces together. A handle may also be included to assist in transporting the apparatus.

The cover 12 and/or the bottom portion 10 have at least one light source 14 mounted thereon to provide the electromagnetic energy to the blood. In embodiments having more than one source 14, the light sources may be separate or a single electromagnetic energy emitter may be used to provide light to two or more sources 14 simultaneously or in some sequence. In preferred embodiments, the source(s) illuminate the interior from a plurality of directions. In a preferred embodiment, the source(s) 14 is attached to a controller (not illustrated) that is set or programmed to deliver light having characteristics as desired for treatment, including, but not limited to, wavelength, power, pulse duration, pulse frequency, and, in some embodiments, to vary the treatment parameters over time. In one embodiment, the bottom portion 10 further comprises a shelf or elevated portion upon which the blood is placed to provide spatial separation between the blood and one or more sources 14.

In preferred embodiments, the interior of at least the bottom portion 10 forms a cooling chamber to allow for storage and transport of the tissue received therein at a lowered temperature, including temperatures sufficient to cause hypothermic arrest. The cooling chamber is cooled by any suitable method or means. In some preferred embodiments, one or more walls 16 of the bottom portion have a cooling means disposed therein, including, but not limited to, electric (or battery) powered cooling equipment (e.g. heat pump, refrigeration, Peltier effect), thermoregulatory fluid, ice, “blue ice”, dry ice, and the like.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention.

What is claimed is:

1. A method for preserving donated blood, said method comprising delivering a preservation effective amount of electromagnetic energy to donated blood, the electromagnetic energy having a wavelength in the visible to near-infrared wavelength range.

2. A method in accordance with claim 1 wherein delivering the effective amount of electromagnetic energy comprises selecting a predetermined power density of energy to deliver to the blood of at least about 0.01 mW/cm².

3. A method in accordance with claim 2 wherein the predetermined power density is selected from the range of about 1 mW/cm² to about 100 mW/cm².

4. A method in accordance with claim 1 wherein the electromagnetic energy has a wavelength of about 630 nm to about 904 mm.

5. A method in accordance with claim 4 wherein the electromagnetic energy has a wavelength of about 810 mm to about 830 nm.

6. A method in accordance with claim 4 wherein the electromagnetic energy has a wavelength of about 670 nm to about 690 nm.

7. A method in accordance with claim 1 wherein delivering the electromagnetic energy comprises delivering the electromagnetic energy to the blood in a hypothermic environment.

8. A method in accordance with claim 7 wherein the blood is placed into a container prior to delivering the energy.

9. A method in accordance with claim 7, wherein the container is a transparent or translucent bag which allows for the passage of the electromagnetic energy.

10. A method in accordance with claim 1 further comprising providing for physiologic gas-exchange for the blood and delivering the electromagnetic energy to the blood in a normothermic environment.

11. A method for treating extracorporeal blood, comprising:
delivering to at least a portion of cellular components of extracorporeal blood electromagnetic energy in a quantity sufficient to prevent or retard damage to cellular components of the blood, said electromagnetic energy having a wavelength of about 630 nm to about 904 nm.

12. A method in accordance with claim 11 wherein the electromagnetic energy has a power density of at least about 0.01 mW/cm².

13. A method in accordance with claim 13 wherein the power density is selected from the range of about 1 mW/cm² to about 100 mW/cm².

14. A method in accordance with claim 11 wherein the electromagnetic energy has a wavelength of about 630 nm to about 904 nm.

15. A method in accordance with claim 14 wherein the electromagnetic energy has a wavelength of about 810 nm to about 830 nm.

16. A method in accordance with claim 14 wherein the electromagnetic energy has a wavelength of about 670 nm to about 690 nm.

17. A method in accordance with claim 11 wherein during treatment the blood resides in a container having a hypothermic environment.

18. A method in accordance with claim 17, wherein the container is a transparent or translucent bag which allows for the passage of the electromagnetic energy.

19. A method in accordance with claim 11, wherein the electromagnetic energy is pulsed during treatment.

20. A method for treating extracorporeal blood, comprising:
delivering to at least a portion of cellular components of extracorporeal blood electromagnetic energy having a wavelength of about 670 nm to about 690 nm and/or about 810 nm to about 830 nm and a power density of at least about 0.01 mW/cm²
wherein the electromagnetic energy is sufficient to increase the useable shelf life of treated blood as compared to untreated blood.
